(19) United States
(12) Patent Application Publication
(10) Pub. No.: US 2004/0148309 A1
(43) Pub. Date: Jul. 29, 2004

(54) Customer fields

(76) Inventor: Hermann Resch, Heidelberg (DE)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/353,779

(22) Filed: Jan. 27, 2003

(51) Int. Cl. G06F 7/00

(52) U.S. Cl. 707/102

(57) ABSTRACT

Systems and techniques to display customized information relating to an automated procurement system are described. In general, in one implementation, the technique includes: receiving information relating to one or more customer fields in a customer data structure, updating the customer data structure using the received information, and displaying a procurement document, including by displaying a plurality of standard data articles from a plurality of standard data fields in a standard data area, and by displaying one or more customer data articles from the one or more customer fields in a customer data area.

### BACKGROUND

The following description relates to customizing of business data objects, for example, the generation and display of added, custom fields in an enterprise resource planning (ERP) system, without the need for extensive coding or manual customizing of the system.

It is normal to ship ERP systems to customers with general functionality built-in, such as the workflow for particular business processes. For example, a procurement system may be delivered to customers with capabilities regarding invoice generation and routing, payment approval rules, and other similar features. Various software items, such as procedures, functions, and database entries, may be associated with these features to make the system operate properly. They may interrelate with each other to provide employees of the customer with a convenient way to automate and analyze the business process using the ERP system. In particular, databases associated with the items may contain particular fields that are assigned to various types of data, such as shipping names and addresses, account information, and process status indicators (e.g., has the product been shipped, has payment been received, etc.).

Because a business' operation is affected by thousands of factors, no two businesses are ever the same. As a result, ERP systems generally require some level of customization after they are initially shipped. The steps in this customization can include simple tasks like filling out electronic forms with information about the ERP system customer, the country in which the system is being used, and other simple information. They can also include complicated modifications on, and extensions of, the fundamental business processes that the system tracks. This customization process can be time-consuming and expensive, and may require the hiring of consultants to modify databases, processes, forms, reports, and user interfaces. The process also is open to errors in coordination. For example, a customer might make certain modifications to the system, but fail to make other related and necessary modifications. Moreover, changes made by the customer may be accidentally overwritten by the central application when the customer upgrades to a new version of the software.

### SUMMARY

This document discloses systems and techniques that allow for simplified and more dependable customization of features in an ERP system by a particular customer. Accordingly, the inventors developed procurement systems and techniques that receive information relating to one or more customer fields in a customer data structure, update the customer data structure using the received information, and display a procurement document, including by displaying a plurality of standard data articles from a plurality of standard data fields (that may be in a first table) in a standard data area, and by displaying one or more customer data articles from the one or more customer fields (that may be in a second table) in a customer data area. The user fields may be in an order in a list, and the information from the user fields may be displayed according to the order of the list. The display may be of an input form, such as an invoice, or an output report, such as a shipping receipt. Also, the display of certain data may be blocked on a particular document. A field reordering command may be received, the order of the customer fields in the list may be changed, and the customer data articles from the one or more customer fields may be displayed according to their order in the list. The display of information from one or more customer fields may also be blocked, such as by an attribute relating to the document, and an external reference related to the procurement document may be associated with the customer data structure.

In another aspect, an article comprising a machine-readable medium stores instructions operable to cause one or more machines to perform operations. The operations may comprise receiving information relating to one or more customer fields in a customer data structure, updating the customer data structure using the received information, and displaying a procurement document, including displaying a plurality of standard data articles from a plurality of standard data fields in a standard data area, and displaying one or more customer data articles from the one or more customer fields in a customer data area. The customer fields may be in an order in a list, and the information from the customer fields may be displayed according to the order of the list. A field reordering command may be received, the order of the customer fields in the list may be changed, one or more customer data items from the one or more customer fields may be displayed (such as in an input form or output report) according to their order in the list.

Details of one or more implementations are set forth in the accompanying drawings and the description below. Other features and advantages may be apparent from the description and drawings, and from the claims.

### DRAWING DESCRIPTIONS

These and other aspects will now be described in detail with reference to the following drawings.

FIG. 1 is a block diagram of an automated procurement system.

FIG. 2 is a block diagram showing components for allowing users of a procurement system to receive data from, and provide data to, the system.

FIG. 3 is a diagram of a document for use in an automated procurement system.

FIG. 4 is a flow chart showing a process for supplementing fields within a database of an automated procurement system.

FIG. 5 is a flow chart showing a process for displaying information from a database that has been supplemented.

FIG. 6 is a screen shot of a shopping cart application displaying customer fields.

Like reference symbols in the various drawings indicate like elements.

### DETAILED DESCRIPTION

The systems and techniques described here relate to the supplementation and modification of database structures that are shipped with a standard enterprise resource planning (ERP) system. These systems and techniques can allow for the customization of a standard ERP system with a minimal effect on the standard ERP code.

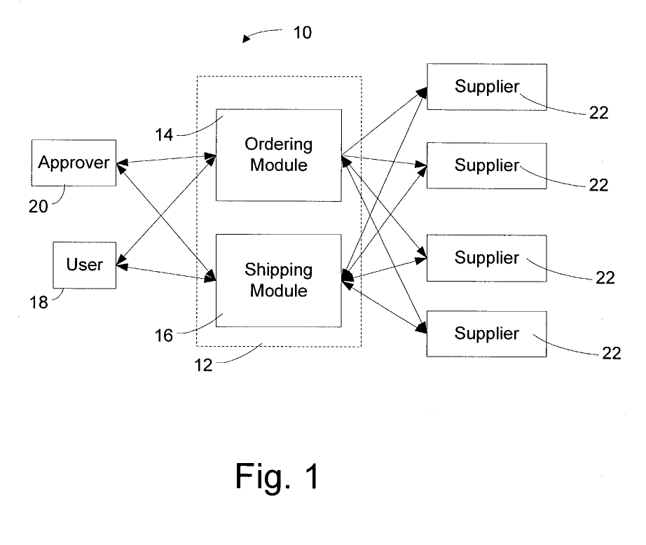

FIG. 1 shows a computerized procurement system 10 that may be used as part of an ERP system. System 10 has a procurement module 12 that may be accessed by various members of an organization (such as employees of a company, or users of a central marketplace). Procurement module 12 may present the users, such as user 18, with information on items that may be procured through system 10. For example, procurement module 12 may supply the user with a list of items that are available in a particular category, along with descriptions and prices for each item. Procurement module 12 may also enable user 18 to select items for procurement, such as by placing them in a virtual shopping cart, and may generate the appropriate paperwork (whether electronic or paper) or workflow (e.g., approvals, payments, and invoice and purchase order routing) needed to carry out any transactions. Procurement module 12 may also interface with other ERP components (not shown), such as business warehouses and financial systems, to allow an entire purchasing business flow to be carried out.

Procurement module 12 may comprise an ordering module 14 and a shipping module 16. Ordering module 14 is responsible for organizing the processes related to the review, selection, and ordering of goods or services, and the approval of such orders. For example, ordering module 14 may provide functionality that allows users to browse catalogs of products to get information about the products, select products the user might want to order and put them in a virtual shopping cart, compare the value of goods in the shopping cart to a pre-set procurement limit, remove goods from the cart, and place an order for goods in the cart. Ordering module 14 can also generate purchase orders, invoices, and confirmations regarding transactions, and aggregate various transactions across departments or organizations.

Ordering module 14 may also be in communication with an approver 20, who can be included in procurement workflow to provide permission for an order. Other users may also be included in the process, and may communicate with ordering module 14. Ordering module 14 may also be provided with additional known features.

Shipping module 16 is responsible for processes relating to the delivery of goods and services, such as the generation of shipping documents and tracking of shipment progress (for products) and project progress (for services).

Procurement module 12 can also communicate, either directly or indirectly, with various suppliers 22. The communication may take place electronically, such as via e-mail, EDI, or XML documents, or by using paper, such as via facsimile. For example, ordering module 14 may aggregate orders from various users, and may periodically send purchase orders to suppliers to fill the orders. In such a situation, the organization may have a pre-existing contract or other agreement with a supplier 22 that governs the terms of the transaction, or the order may be accompanied by an agreement process (which is generally brief and informal, and based on standard terms) regarding the terms of performance. Shipping module 16 may also communicate with suppliers 22, for example, in the tracking of shipments from suppliers 22, and in providing feedback to the suppliers 22 regarding the quality of service or goods (e.g., by returning products and tracking those returns, and in the resolution of disputes over performance).

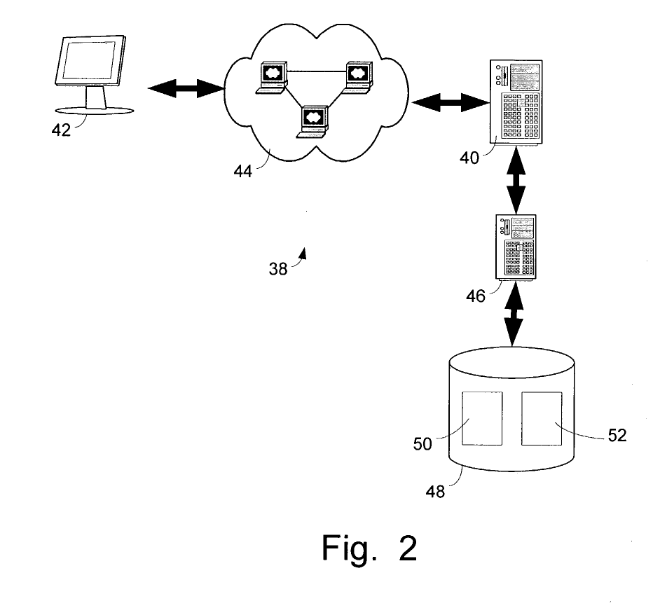

FIG. 2 is a block diagram showing components for allowing users of a procurement system 38 to receive data from, and provide data to, the system 38. The system 38 is established as a client-server system, so that access is via a client 42, which may be a personal computer, workstation, thin client, personal digital assistant (PDA), wireless telephone, or other such device. Client 42 communicates through a network 44, which may include, for example, a LAN, WAN, intranet, or the Internet. On the server side, communication may be managed by an Internet transaction server 40, which may communicate with client 42 using any appropriate means of communication, such as with HTML, XML documents, JAVA applets, or other means.

Procurement applications may be managed by application server 46, which receives requests for data from Internet transaction server 40, and provides the required data so that it can be reviewed by a user at client 42. Application server 46 may also provide services such as spooling, formatting of data, and the dispatch of user requests. Data may be stored in, and accessed from, database 48, which may reside on a database server, and may contain a variety of tables or other data structures for storing the data that is needed to manage a procurement system, and more broadly an ERP.

Database 48 is shown to include two tables-standard table 50 and customer table 52. Standard table 50 includes structures, such as database fields, needed for a generalized procurement transaction. For example, standard table 50 may include fields (standard fields) for a transaction number (e.g., purchase order number), buyer and seller address information, item prices, total order prices, and other factors that are present in most purchasing transactions. Generally, the standard fields will be selected so as to provide the owner of the ERP system with a functional system that can be made operational without much effort, but also without so much detail that the system becomes confusing and unwieldy. The information may also be spread over multiple tables, such as where party information is stored in a central area, and information on particular transactions is stored in a different area.

Customer table 52 may be made available for customers who would like to add additional functionality to the system 38. For example, a company may want to provide an additional field that would cause a check-box to be displayed to purchasers, so that the purchasers can indicate whether they need rush shipment of a product (such as a pharmaceutical drug). Also, a customer may wish to have an additional address field on certain documents to indicate a particular building number or other identifier for delivery on a large campus that has many buildings. Customers may also wish to create additional fields that will allow them to map the operation of system 38 to their existing back-end system (such as an accounting and financial system).

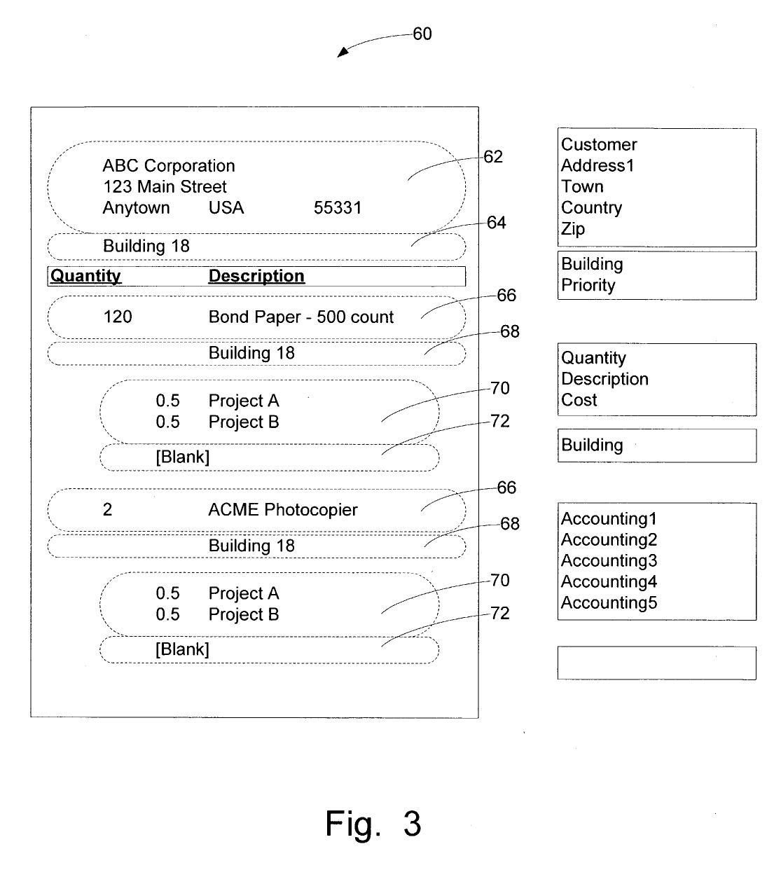

FIG. 3 is a diagram of a document 60 for use in an automated procurement system. The document 60 could be any type of document used for input or reporting in an automated procurement system, such as a shopping cart representation, a purchase order, an invoice, a shipping document, or a confirmation. In general, document 60 comprises multiple areas in which information can be displayed or received, where each area has a standard area and a customer area.

For example, standard header area 62 displays information in the form of a number of articles, that are generally defined a single time for a trading partner or transaction, such as an invoice number, a company name, and a delivery address. Customer header area 64, includes additional information, such as a check box that indicates a need for rush delivery (e.g., for use with certain pharmaceutical orders) or special addressing information, such as a specific building number for a large corporate campus.

Standard item areas 66 may display information on items to be procured via the document, such as quantity, description, and price. Customer item areas 68 may include information regarding special handling instructions for a particular item or other item-specific requirements. Standard accounting areas 70 may include information that indicates responsibilities for particular orders. For example, if a purchase order covers supplies for a particular department, standard accounting area may include information that identifies the relative responsibilities of the various projects in the department to pay for the items (e.g., Project A 50%, and Project B 50%). Customer accounting areas 72 may include additional information, such as the names of individuals that are contacts for payment for the ordered items.

Each of the areas on document 60 may have a corresponding data structure, which may include fields that hold data that is displayed in the corresponding display area. Each area could also have multiple corresponding data structures. In particular, each of the customer areas may have a corresponding structure that is created to manage information that is added by the user to customize the system. The customer structures may be empty or essentially empty in the standard ERP system as it is shipped to the customer. The structures may also be given unique names in the standard system, so that a user and the system can easily identify them, and so that they are not overwritten when the system is updated. Each document that is provided by the system may have such structures correspond to it, as appropriate, to allow user manipulation of the system.

Various data structures that correspond to the information displayed in document 60 are shown to the right of document 60 as lists of fields. For example, standard header area 62 corresponds to a structure having five fields, while customer header area 64 corresponds to a structure having two fields. One field, the building to which the order is to be shipped, is shown in document 60, while a second field has been blocked from being displayed in document 60, such as by setting an appropriate attribute indicator associated with the document. Standard item areas 66 have a corresponding structure that has three fields, while customer items areas 68 have a corresponding structure with one field. Standard accounting areas 70 have a corresponding structure with five fields. No customizing information for the customer accounting area 72 in FIG. 3 has been entered, so the corresponding structure is shown as empty.

With the structures in place, a user at the customer (such as a system administrator) can identify a structure by its name or in another manner, and add fields to the structure. These fields will be listed for the structure, and may hold data relating to particular records in the system. A customer structure may also contain a reference to one or more standard structures for the system, where appropriate.

Where a user would like to have several structures share a field or fields, the user may use a reference to a single set of fields from each of the structures, such as by using an SAP customizing include. As such, the user will establish a list of fields and provide an external reference (e.g., an include) at each structure to the list. In this manner, each of the structures will refer to a single source for field definitions. As a result, data integrity may be automatically maintained for the structures, because any changes in the field definitions will be seen by all of the structures. The system can thus allow a customer to add material to various forms in a relatively flexible manner with a minimum of programming.

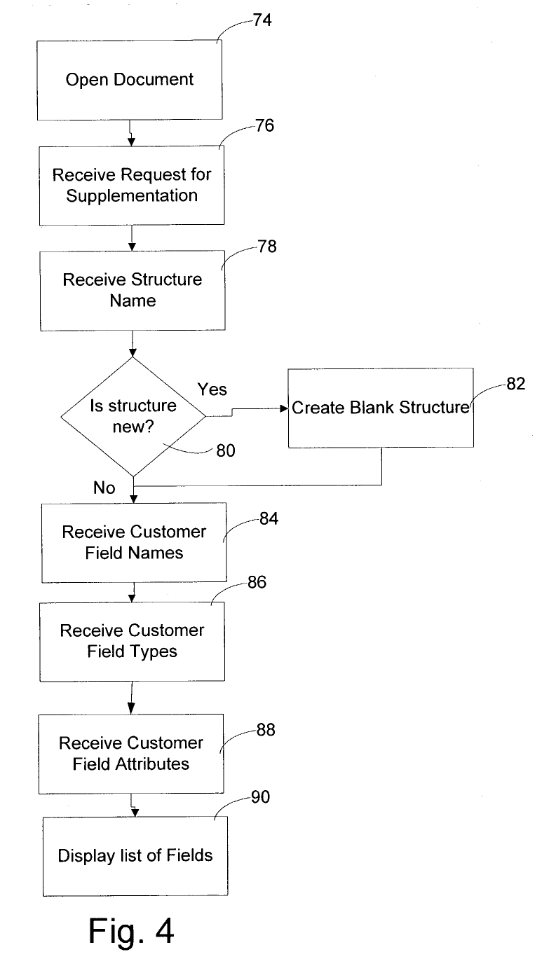

FIG. 4 is a flow chart showing a process for supplementing fields within a database of an automated procurement system. At box 74, the user opens a document, such as a shopping cart or invoice, for editing. At box 76, the user may select a customer structure to supplement, and provide the system with a name for the structure, as shown by box 78. If the structure name is new, as determined at box 80, a new empty structure, such as an empty database table, may be created. Once the structure has been created, or if creation is not necessary, the system may receive from the user, at box 84, field names that the customer would like to maintain, via the customer structure, in addition to the standard fields. For each field, the system may also receive a field type, at box 86. For example, the user may define the box to receive numerals or dollar amounts. When another user later enters data for the field in a document, the entered data may be verified against the type to ensure that the user did not make an obvious mistake (such as by entering alpha characters into a field for currency values). The system may also receive, at box 88, attributes for any fields that are added. For example, the value of the attributes may control whether a field is displayed by the applications that access the field, or whether the field can be edited or simply viewed. Each field may also be associated with a label that is displayed with the field, or the field name may serve as the label. Attributes may also be assigned in other manners, such as by using an SAP business add-in (BADI) tool, which is a general tool that permits custom programming to be referenced at particular points in an SAP system, so that updates to the base system do not interfere with the custom code.

The added customer fields may be ordered in a field list to allow simplified organization and review, as shown at box 90. The user may then reorganize the fields using well-known editing features such as drag-and-drop item movement. For example, customer fields may initially be displayed in the field list according to the order in which they were created. If a user creates a new field that relates closely to a field at the top of the field list, the user can drag the new field to the top of the field list to better organize the list. Customer fields may be displayed in a field list that is separate from a field list for the standard fields, or they may be combined with the field list for the standard fields. In addition to providing visual organization for the fields, the order of the fields in the field list can also be used to control the location at which each display item that corresponds to the various fields is displayed to a user, as described in more detail below.

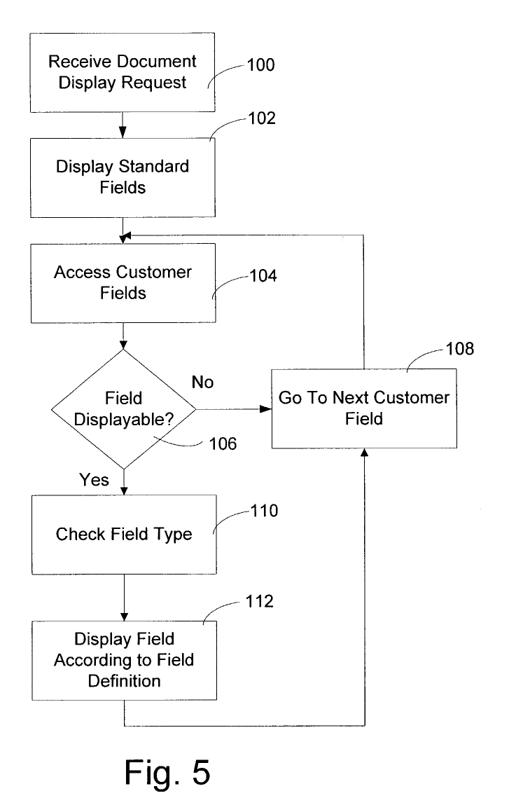

FIG. 5 is a flow chart showing a process for displaying information from a database that has been supplemented. In general, the process displays information corresponding to standard fields in a defined display area, and displays information corresponding to added customer fields in another defined display area. At box 100, the system receives a request to display a particular type of document, such as an invoice or purchase order. Certain items on the document may be associated with particular fields in one or more databases. For example, one database may contain information about a particular trading partner of the customer. The database may contain identification numbers of trading partners, along with their identification information, such as names, shipping addresses, and billing addresses. Thus, for example, in a purchase order, certain portions of the standard display area may provide an opportunity for a user to enter information to identify a partner, and the system may then fill in the remaining items in the standard display area. The items may be presented as input items or output items (which are displayed but cannot be edited from the document), or combined input and output items (which display a value of a field but permit the value to be overridden), depending on the needs of the application.

Each document is configured to display particular data. As shown at box 102, the document, when called, may first look for information relating to the standard fields corresponding to the document. With the standard fields displayed, the process looks for, and begins accessing, any customer fields that have been created, as indicated by box 104. The process may proceed through the fields according to their order in the field list. If the first customer field is one that may not be displayed (e.g., its display attribute is set to hidden), the process moves to the next field in the field list. If the first customer field may be displayed, it is displayed in the first available space in the customer display area, and according to the format that matches its defined type, as shown at box 110. For example, a text box that is the first customer field on the customer field list may be displayed in the upper left corner of the customer display area, taking up a rectangle having a certain defined height and width, as indicated by box 112.

Once the customer field is displayed, the system may access the next customer field as shown by box 108, and the process may continue down through all of the customer fields on the field list. As each field is accessed, it may be placed in a determined position relative to the previously-displayed field if it is displayable. Where the document has multiple standard structures and corresponding customer structures (such as for the document shown in FIG. 3), the process described above may alternate between the displays of each type of information. Also, the standard structures may have attributes that affect the display of a field like the attributes for the customer structures.

Alternatively, the customer fields may be fully intermingled with the standard fields on the field list, so that, for example, customer fields and standard fields alternate even within the header area of a document. In such a situation, each article that is associated with a field may be placed in a determined location relative to the article associated with the preceding field in the field list. The manipulation of various fields may be assisted using tools such as the SAP data dictionary, which is a repository for metadata including table definitions, allowed values for certain data, and definitions of relationships between tables. Moreover, where additional control over the display of user fields is desired, tools such as SAP Dynpro may be used to provide additional customization.

Where a common reference has been made by multiple documents to a single field list, such as by using an SAP customizing include, it may be beneficial to control the display of the fields in the various documents. For example, although a price field may be needed on an invoice and in a shopping cart document, it may not be needed on a shipping document. However, if the shipping document has made a common reference to a list of fields that includes a price field, the document will access the price information. To prevent the display of the price in shipping documents, those documents may assign an attribute to the price field that prevents the display of the field values in the particular document. Thus, in this manner, a user can have the convenience of a common reference in multiple documents to a single field definition, but can maintain the flexibility to control the display of the reference on a document-by-document basis.

An example of a business add-in method, like that discussed above to control the display of certain fields, is shown below. The method first checks the name of the user; if the name is “EMPLOYEE1,” the fields for the user are passed through, and the edit property (called “xinput”) is set to blank, so that the fields in ls-fields cannot be edited by the user. Also, when the field “EILKZ” is encountered during the looping, its property named “xdisplay” is set to a blank so that it is not displayed to the user known as EMPLOYEE1. The remaining fields are set to have an attribute of “X,” and are displayed to the user.

```
METHOD if_ex_bbp_cuf_badi_2˜modify_screen.
  DATA: ls_fields TYPE bbps_cuf_display.
  CHECK sy-uname = ‘EMPLOYEE1’.
  LOOP AT et_fields INTO ls_fields.
    ls_fields-xinput = ‘’.
    IF ls_fields-fieldname = ‘EILKZ’.
      ls_fields-xdisplay = ‘’.
    ELSE.
      ls_fields-xdisplay = ‘X’.
    endif.
    MODIFY et_fields FROM ls_fields.
  ENDLOOP.
ENDMETHOD.
```

The described system may provide one or more benefits to a customer of an ERP system. Because the process described above provides for substantially automated display of added fields in a system, the system administrator may more easily customize the ERP system to meet the needs of an organization's users. In addition, users who have limited development skills may be given the ability to modify the system in various ways. As a result, deployment of the ERP system may be much easier and less expensive. Also, errors in customization can be minimized.

The internet transaction server described above may assist in the display of the documents associated with the particular fields. When a document is called for, the server checks the field list to determine if there are fields to be displayed, and may then extract information from the databases associated with the field list for display in a web environment. The customer fields may be named in a certain manner so that the transaction server can identify them if special processing is needed.

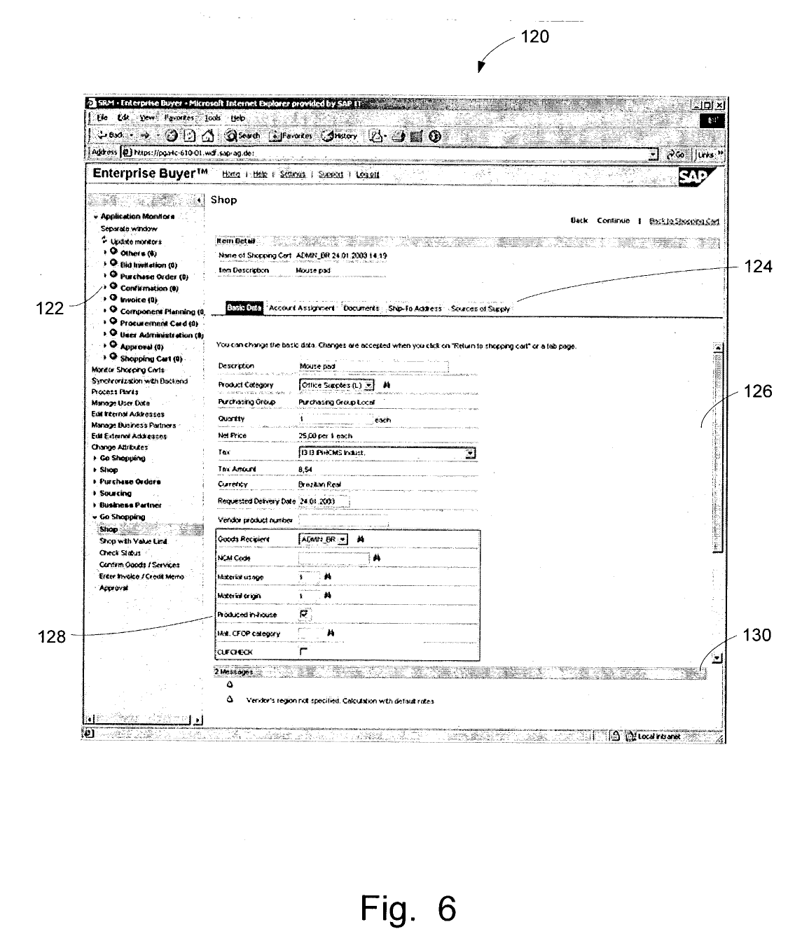

FIG. 6 is a screen shot of a shopping cart application that displays customer fields. Display 120 shows the manner in which a part of a shopping cart can be displayed to a user of an automated procurement system. For example, a secretary in an organization may be presented with display 120 in the process of ordering office products for a department. Display 120 includes a navigation area 122 that allows the user to move to other displays related to the procurement process. For example, the user can monitor the status of various purchase orders and other shopping carts. Tab display area 124 shows the user other pages within the particular area that can be displayed. For instance, display 120 shows information related to a particular item, a computer mouse pad, that the user is considering procuring. Other pages show related information for the potential order, such as the account to which the purchase is to be assigned, documents that relate to the purchase, the address to which the mouse pad is to be shipped, and the source of the mouse pad to be delivered (e.g., internal inventory or an outside supplier). Detail display area 126 shows the information related to the order in various display articles, some of which may be altered by the user. For example, in the figure, the user has presently selected a single mouse pad, but could enter a different number to be delivered.

A customer defined area 128 of detail display area 126 shows display articles that relate to customer fields. For example, in the figure, the organization for which the user works manufactures items such as mouse pads, so a “produced in-house” check box is checked. Also, a particular recipient for the goods has been identified so as to provide more particularity for delivery than can be provided by a simple shipping address. Other similar information could also be added to the form, as described above. Most of the remainder of the detail display area 126 shows a standard display area.

Message area 130 provides to the user information relating to the order. For example, message area 130 can notify the user if a particular order may encounter problems (e.g., delayed delivery because of possible supply problems), or it could provide reminders to a user that assist in the ordering process.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back-end component (e.g., as a data server), or that includes a middleware component (e.g., an application server), or that includes a front-end component (e.g., a client computer having a graphical user interface or a Web browser through which a user can interact with an implementation of the systems and techniques described here), or any combination of such back-end, middleware, or front-end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

Although only a few embodiments have been described in detail above, other modifications are possible. Portions of this disclosure discuss particular implementations of a customizable procurement system, but other implementations are also possible. The logic flows depicted in FIGS. 4 and 5 do not require the particular order shown, or sequential order, to achieve desirable results. For example, the identification of user structures may be performed at many different places within the overall process. In certain implementations, multitasking and parallel processing may be preferable.

Other embodiments may be within the scope of the following claims.

What is claimed is:

1. A computer-implemented method for providing updated information relating to an automated procurement system, comprising:
receiving information relating to one or more customer fields in a customer data structure;
updating the customer data structure using the received information; and
displaying a procurement document, including displaying a plurality of standard data articles from a plurality of standard data fields in a standard data area, and displaying one or more customer data articles from the one or more customer fields in a customer data area.

2. The computer-implemented method of claim 1, wherein the customer fields are in an order in a list, and the information from the customer fields is displayed according to the order of the list.

3. The computer-implemented method of claim 2, further comprising receiving a field reordering command, changing the order of the customer fields in the list, and displaying one or more customer data articles from the one or more customer fields according to their order in the list.

4. The computer-implemented method of claim 1, wherein the standard data articles and the customer data articles are displayed on an input form.

5. The computer-implemented method of claim 1, wherein the standard data articles and the customer data articles are displayed on an output report.

6. The computer-implemented method of claim 5, wherein the output report comprises an invoice.

7. The computer-implemented method of claim 5, wherein the output report comprises a shipping document.

8. The computer-implemented method of claim 1, wherein the plurality of standard fields are stored in a first table, and the one or more customer fields are stored in a second table.

9. The computer-implemented method of claim 1, further comprising blocking the display of information from one or more customer fields.

10. The computer-implemented method of claim 1, further comprising associating with the customer data structure an external reference related to the procurement document.

11. The computer-implemented method of claim 10, further comprising blocking the display of information from one or more customer fields.

12. The computer-implemented method of claim 11, wherein the blocking is controlled by attributes relating to the document and defined for each of the one or more customer fields.

13. The computer-implemented method of claim 1, wherein the standard data area comprises an item area, and the customer data area comprises an item area.

14. An article comprising a machine-readable medium storing instructions operable to cause one or more machines to perform operations comprising:
receiving information relating to one or more customer fields in a customer data structure;
updating the customer data structure using the received information;
displaying a procurement document, including displaying a plurality of standard data articles from a plurality of standard data fields in a standard data area, and displaying one or more customer data articles from the one or more customer fields in a customer data area.

15. The article of claim 14, wherein the customer fields are in an order in a list, and the information from the customer fields is displayed according to the order of the list.

16. The article of claim 14, further comprising receiving a field reordering command, changing the order of the customer fields in the list, and displaying one or more customer data articles from the one or more customer fields according to their order in the list.

17. The article of claim 14, wherein the standard data articles and the customer data articles are displayed on an input form.

18. The article of claim 14, wherein the standard data articles and the customer data articles are displayed on an output report.

19. The article of claim 14, wherein the plurality of standard fields are stored in a first table, and the one or more customer fields are stored in a second table.

20. The article of claim 14, further comprising associating with the customer data structure an external reference related to the procurement document.

21. The article of claim 14, further comprising blocking the display of information from one or more customer fields.
